(19) United States
(12) Patent Application Publication
(10) Pub. No.: US 2026/0296436 A1
(43) Pub. Date: Oct. 1, 2026

(54) VEHICLE CONTROL DEVICE

(71) Applicant: HONDA MOTOR CO., LTD., Tokyo (JP)

(72) Inventors: Kanta MORISHITA, Tokyo (JP); Tomokazu MITSUI, Tokyo (JP); Yuki KIZUMI, Tokyo (JP)

(73) Assignee: HONDA MOTOR CO., LTD., Tokyo (JP)

(21) Appl. No.: 19/578,268

(22) Filed: Mar. 25, 2026

(30) Foreign Application Priority Data
Mar. 28, 2025 (JP) 2025-055970

(51) Int. Cl. B60W 30/18

(52) U.S. Cl. CPC B60W 30/18154; B60W 2552/53; B60W 2720/106

(57) ABSTRACT

A vehicle control device for controlling a vehicle includes: a processor configured to: estimate, when the vehicle is scheduled to travel to an intersecting road across an oncoming lane at an intersection, a stop position of the vehicle at the intersection; and perform travel control on the vehicle. The processor estimates a turning start position of the vehicle when the vehicle travels to the intersecting road as the stop position based on map information, and the processor performs deceleration control on the vehicle based on estimated the stop position.

### CROSS-REFERENCE TO RELATED APPLICATIONS

This application is based on and claims priority under 35 USC 119 from Japanese Patent Application No. 2025-055970 filed on Mar. 28, 2025, the contents of which are incorporated herein by reference.

### TECHNICAL FIELD

The present disclosure relates to a vehicle control device.

### BACKGROUND

In recent years, active efforts have been made to provide access to a sustainable transportation system in consideration of vulnerable traffic participants. As one of these efforts, research and development on driving assistance techniques and autonomous driving techniques for vehicles such as automobiles have been made in order to further improve safety and convenience of traffic.

As an example of the driving assistance techniques, Japanese Patent Application Laid-Open Publication No. 2023-013304 discloses a technique in which when a stop line is detected based on map information stored in a high-definition road map database, an own vehicle is decelerated at a deceleration calculated based on a distance from the own vehicle to the stop line.

In the related art, for example, map information including stop line information such as the high-definition road map database is required.

However, since general map information often does not include information on the stop line, a technique capable of estimating an appropriate stop position even if no information on the stop line is included in the map information is desired.

The present disclosure provides a vehicle control device capable of estimating an appropriate stop position even if no information on a stop line is included in map information, and appropriately controlling a vehicle based on the stop position. This further improves the safety of traffic and contributes to development of a sustainable transportation system.

### SUMMARY

A first aspect of the present disclosure relates to a vehicle control device for controlling a vehicle includes: a processor configured to: estimate, when the vehicle is scheduled to travel to an intersecting road across an oncoming lane at an intersection, a stop position of the vehicle at the intersection; and perform travel control on the vehicle. The processor estimates a turning start position of the vehicle when the vehicle travels to the intersecting road as the stop position based on map information, and the processor performs deceleration control on the vehicle based on estimated the stop position.

According to the present disclosure, it is possible to provide a vehicle control device capable of estimating an appropriate stop position even if no information on the stop line is included in the map information, and appropriately controlling the vehicle based on the stop position.

### BRIEF DESCRIPTION OF DRAWINGS

Exemplary embodiment(s) of the present disclosure will be described in detail based on the following figures, wherein

FIG. 1 is a block diagram showing a schematic configuration of a vehicle 1 including a control device 30 that is an embodiment of a vehicle control device of the present disclosure;

FIG. 2 is a diagram illustrating a stop position SL and a stop position frame SF when the vehicle 1 turns right at an intersection IS;

FIG. 3 is a diagram illustrating a method of obtaining a turning start position Ps setting as the stop position SL;

FIG. 4 is a diagram (part 1) illustrating a method of correcting the stop position SL;

FIG. 5 is a diagram (part 2) illustrating the method of correcting the stop position SL;

FIG. 6 is a diagram (part 3) illustrating the method of correcting the stop position SL; and

FIG. 7 is a flowchart showing an example of a processing procedure performed by the control device 30.

### DESCRIPTION OF EMBODIMENTS

Hereinafter, an embodiment of a vehicle control device of the present disclosure will be described with reference to the drawings. The drawings are viewed in directions of reference numerals. The following embodiment does not limit the present disclosure, and not all elements described in the following embodiment are essential to the present disclosure. Further, two or more elements described in the following embodiment may be freely combined without departing from the gist of the present disclosure. In the following description, the same or similar elements are denoted by the same or similar reference numerals, and a description thereof may be omitted or simplified.

In the present description and the like, in order to simplify and clarify the description, front-rear (including near-far), left-right, and upper-lower directions are described according to directions seen from a driver who is an occupant of a vehicle (a vehicle 1 to be described later), and in the drawings, a front side of the vehicle is denoted by Fr, a rear side is denoted by Rr, a left side is denoted by L, and a right side is denoted by R.

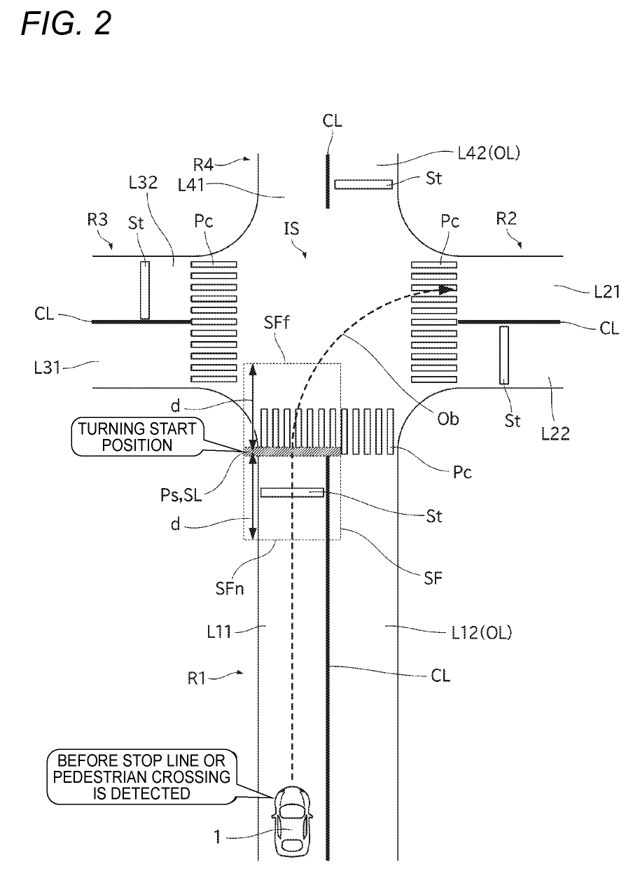

Further, the following embodiment will assume a left-hand traffic region such as Japan and describe an example in which one side in a vehicle width direction in the present disclosure is set to a left side and the other side in the vehicle width direction is set to a right side, but is not limited thereto. For example, when the present disclosure is applied to a right-hand traffic region such as the United States of America or the People's Republic of China, the one side in the vehicle width direction in the present disclosure may be set to the right side, and the other side in the vehicle width direction may be set to the left side. In this case, "turn right" and "turn left" in the following description may be interpreted as "turn left" and "turn right", respectively, and FIGS. 2 to 6 and the like may be viewed with the left and right reversed as necessary.

### 1. Vehicle

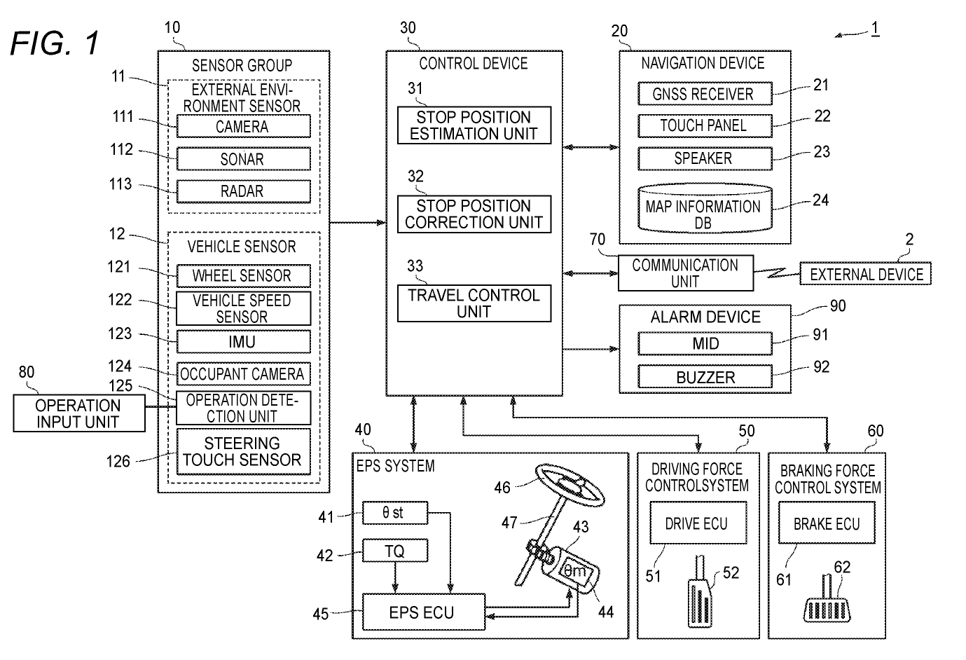

FIG. 1 is a block diagram illustrating a schematic configuration of the vehicle 1 including a control device 30 that is an embodiment of a vehicle control device of the present disclosure. The vehicle 1 according to the present embodiment shown in FIG. 1 is an automobile including a drive source (not shown), and wheels (not shown) including drive wheels driven by power of the drive source and steered wheels that are steerable. As an example, the vehicle 1 can be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

The vehicle 1 includes a sensor group 10, a navigation device 20, the control device 30, an electric power steering (EPS) system 40, a driving force control system 50, a braking force control system 60, a communication unit 70, an operation input unit 80, and an alarm device 90.

The sensor group 10 includes an external environment sensor 11 that acquires information related to a periphery of the vehicle 1 (hereinafter referred to as "external environment information"), and a vehicle sensor 12 that acquires information related to the vehicle 1. The information (in other words, a detection value) acquired by each sensor in the sensor group 10 is output to the control device 30, and is used by the control device 30 to control the vehicle 1.

The external environment sensor 11 includes, for example, cameras 111, a sonar 112, and a radar 113. Each of the cameras 111 is an imaging device that images the periphery of the vehicle 1 including a front side of the vehicle 1 and outputs image data of an obtained peripheral image to the control device 30. As the camera 111, for example, a digital camera using an imaging element such as a charge coupled device (CCD) or a complementary metal oxide semiconductor (CMOS) can be adopted.

The sonar 112 emits sound waves to the periphery of the vehicle 1 (for example, the front side, a rear side, and lateral sides of the vehicle 1), and receives reflected sounds from an object present in the periphery of the vehicle 1, thereby detecting a distance to the object, a direction of the object, and the like. The radar 113 emits radio waves to the periphery of the vehicle 1 including the front side of the vehicle 1, and receives reflected waves from an object present in the periphery of the vehicle 1, thereby detecting a distance to the object, an azimuth of the object, and the like. As the radar 113, for example, a millimeter wave radar can be adopted.

The external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels among the wheels of the vehicle 1. As an example, the wheel sensor 121 detects a rotation angle of each of the left rear wheel and the right rear wheel. The wheel sensor 121 may be, for example, an angle sensor or a displacement sensor.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not shown) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained interior image to the control device 30. For example, the occupant camera 124 may be a so-called "driver monitor camera" that is capable of imaging a head of an occupant who sits on the driver's seat of the vehicle 1 (hereinafter, also referred to as a "driver") from the front (in other words, imaging a face). As the occupant camera 124, a digital camera using an imaging element such as the CCD or the CMOS can be adopted, similarly to the camera 111.

The operation detection unit 125 detects an operation performed by using the operation input unit 80 that is operable by the driver. In the present embodiment, the operation input unit 80 may include, for example, an operation button for receiving an operation to switch between on (in other words, operation) and off (in other words, non-operation) of predetermined driving assistance control such as steering control performed by a travel control unit 33 to be described later. In this case, the operation detection unit 125 can detect an operation of turning on/off the predetermined driving assistance control.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the driver when the steering 46 is gripped appropriately.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (hereinafter referred to as map information DB) 24 as an example of a map information or the like.

The map information DB 24 includes road network information. The road network information is information representing roads based on a combination of nodes and links connecting the nodes (also referred to as "paths"). Each of the nodes in the road network information represents, for example, a feature of a corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of a corresponding link, a road corresponding to the corresponding link, a link length, a lane number, a travel direction, a road type, and the like is set.

In the present embodiment, the map information DB 24 can be, for example, a standard definition map (SD map) that is general map information. The SD map is map information having a smaller amount of information than high-definition map information called "HD map (High-Definition Map)". Such an SD map may not include, for example, information on a stop line St (for example, information indicating a position of the stop line St) to be described later. Since the SD map and the HD map are known, a detailed description thereof will be omitted here.

The GNSS receiver 21 specifies a current position of the vehicle 1 (for example, a latitude and a longitude of a location where the vehicle 1 is located) based on a signal received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

The touch panel 22 is implemented by, for example, combining a display device such as a liquid crystal display or an organic light emitting diode (OLED) with a pointing device (for example, a touch pad). The speaker 23 is configured to output a sound to the occupant (for example, the driver) of the vehicle 1.

For example, the navigation device 20 searches for a route from the current position of the vehicle 1 to a destination set by the driver using the touch panel 22 by referring to the map information database 24. Then, the navigation device 20 performs route guidance using the touch panel 22 and the speaker 23 based on the found route. The navigation device 20 may cause the touch panel 22 to perform a predetermined display according to an instruction from the control device 30. Further, the navigation device 20 may output, for example, information indicating the specified current position of the vehicle 1 or predetermined information (for example, information indicating an operation received via the touch panel 22) to the control device 30.

In the present embodiment, the control device 30 is configured to refer to the map information DB 24 (that is, the map information) of the navigation device 20. However, the present disclosure is not limited thereto, and map information including the road network information similar to that of the map information DB 24 may be separately stored in the control device 30 or the like, and the control device 30 may refer to such map information. Further, the control device 30 may appropriately acquire the map information from an external device 2 via the communication unit 70 to be described later or the like.

The control device 30 is a computer that includes, for example, a processor that performs various calculations, a storage unit having a non-transitory storage medium (for example, a flash memory) for storing various types of information, and an input and output unit that controls input and output of data between the inside and the outside of the control device 30 (none is shown), and generally controls the entire vehicle 1. For example, the control device 30 is implemented by one electronic control unit (ECU) or by a plurality of ECUs working in cooperation with each other.

In the present embodiment, for example, the control device 30 is configured to recognize a peripheral situation of the vehicle 1 based on information (for example, point cloud information) obtained by performing predetermined sensor fusion processing on detection results of a part or all of the cameras 111, the sonar 112, and the radar 113 provided in the external environment sensor 11.

For example, the control device 30 recognizes a position, a type, a speed, an acceleration, and the like of the object present in the periphery of the vehicle 1 as the peripheral situation of the vehicle 1. At this time, the control device 30 recognizes the position of the object as, for example, a position on an absolute coordinate system in which a predetermined representative point such as a center of gravity or a center of a drive shaft of the vehicle 1 is set as an origin. In the absolute coordinate system, the position of the object may be represented using a representative point such as a center of gravity or a corner of the object, or may be represented as an area.

Examples of the object that can be recognized by the control device 30 include road division lines such as lane lines for defining lanes, curbs, and medians, road structures such as guardrails and road shoulders, road markings, road signs, stop lines, and pedestrian crossings. Further, the control device 30 may also recognize, for example, other road events such as traffic lights, branches, merging, interchanges, and tollgates of toll roads, and traffic participants such as other vehicles and pedestrians. Since a specific control example of the control device 30 will be described later, a description thereof will be omitted here.

The EPS system 40 includes, for example, a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the driver in operating the steering 46 by applying, according to an instruction from the EPS ECU 45, a driving force or a reaction force to a steering column 47 connected to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a driving ECU 51, and is configured to control a driving force of the vehicle 1. The driving ECU 51 is a computer that includes, for example, a processor that performs various calculations, a storage unit including a non-transitory storage medium that stores various types of information, and an input and output unit that controls input and output of data between the inside and the outside of the driving ECU 51 (none is shown), and controls the driving force control system 50. The driving ECU 51 is implemented by one or more ECUs. For example, based on an operation on an accelerator pedal 52 provided in the vehicle 1, the driving ECU 51 controls the power output from the drive source of the vehicle 1. The driving ECU 51 can also control the driving force control system 50 (for example, the drive source) according to an instruction from the control device 30.

The braking force control system 60 includes a braking ECU 61, and is configured to control a braking force of the vehicle 1. The braking ECU 61 is a computer that includes, for example, a processor that performs various calculations, a storage unit including a non-transitory storage medium that stores various types of information, and an input and output unit that controls input and output of data between the inside and the outside of the braking ECU 61 (none is shown), and controls the braking force control system 60. The braking ECU 61 is implemented by one or more ECUs. For example, the braking ECU 61 controls the braking force of the vehicle 1 by controlling a brake device (not shown) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls an electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with the external device 2 under control of the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be used for communication between the vehicle 1 and the external device 2.

The alarm device 90 is a device that alarms the driver under the control of the control device 30. The alarm device 90 includes, for example, a multi-information display (MID) 91 and a buzzer 92.

The MID 91 is implemented by a display device such as a liquid crystal display or an OLED, and is provided at a position that the driver can visually recognize (for example, in a meter panel of the vehicle 1). For example, the MID 91 displays a predetermined alarm image according to an instruction from the control device 30. The MID 91 may be integrated with the touch panel 22 described above. That is, the "MID 91" in the following description may be interpreted as the "touch panel 22".

The buzzer 92 is configured to output a predetermined alarm sound. For example, the buzzer 92 outputs a predetermined alarm sound according to an instruction from the control device 30. The buzzer 92 may be integrated with the speaker 23 described above. That is, the "buzzer 92" in the following description may be interpreted as the "speaker 23".

### 2. Control Device

Next, the control device 30 will be described in more detail. As shown in FIG. 1, the control device 30 includes, for example, a stop position estimation unit 31, a stop position correction unit 32, and the travel control unit 33. Each of these function units is implemented by the processor of the control device 30 executing the program stored in the storage unit.

### Example of Assumed Situation

In order to simplify and clarify the following description, first, an example of a situation assumed in the present embodiment will be described. In the present embodiment, for example, it is assumed that the vehicle 1 turns right at the intersection IS shown in FIGS. 2 and 4 to 6.

As shown in FIG. 2 and the like, the intersection IS is, for example, a four-way intersection in which a travel road R1, a right-side intersecting road R2, a left-side intersecting road R3, and an opposite-side road R4 are connected.

The travel road R1 is a road on which the vehicle 1 is currently traveling, and is a two-lane road having a first lane L11 that is a lane (that is, an own lane) on which the vehicle 1 is currently traveling and a second lane L12 whose travel direction is opposite to that of the first lane L11. More specifically, the travel direction of the first lane L11 of the travel road R1 is a direction from a lower side to an upper side in FIGS. 2 and 4 to 6. The travel direction of the second lane L12 of the travel road R1 is a direction from the upper side to the lower side in FIGS. 2 and 4 to 6. Further, on the travel road R1, the first lane L11 and the second lane L12 are separated by a central division line CL.

The right-side intersecting road R2 is a road present on a right side of the travel road R1, and is a two-lane road having a first lane L21 and a second lane L22 whose travel direction is opposite to that of the first lane L21. More specifically, the travel direction of the first lane L21 of the right-side intersecting road R2 is a direction from a left side to a right side in FIGS. 2 and 4 to 6. Further, the travel direction of the second lane L22 of the right-side intersecting road R2 is a direction from the right side to the left side in FIGS. 2 and 4 to 6. Further, on the right-side intersecting road R2, the first lane L21 and the second lane L22 are separated by the central division line CL.

The left-side intersecting road R3 is a road present on an opposite side (that is, on a left side of the travel road R1) of the right-side intersecting road R2 with the intersection IS interposed therebetween, and is a two-lane road having a first lane L31 and a second lane L32 whose travel direction is opposite to that of the first lane L31. More specifically, the travel direction of the first lane L31 of the left-side intersecting road R3 is a direction from the right side to the left side in FIGS. 2 and 4 to 6. The travel direction of the second lane L32 of the left-side intersecting road R3 is a direction from the left side to the right side in FIGS. 2 and 4 to 6. Further, on the left-side intersecting road R3, the first lane L31 and the second lane L32 are separated by the central division line CL.

The opposite-side road R4 is a road present on an opposite side of the travel road R1 with the intersection IS interposed therebetween, and is a two-lane road having a first lane L41 and a second lane L42 whose travel direction is opposite to that of the first lane L41. More specifically, the travel direction of the first lane L41 of the opposite-side road R4 is a direction from the lower side to the upper side in FIGS. 2 and 4 to 6. The travel direction of the second lane L42 of the opposite-side road R4 is a direction from the upper side to the lower side in FIGS. 2 and 4 to 6. Further, on the opposite-side road R4, the first lane L41 and the second lane L42 are separated by the central division line CL.

In the example shown in FIG. 2 and the like, a pedestrian crossing Pc and the stop line St are provided on a near side of the intersection IS on each of the travel road R1, the right-side intersecting road R2, and the left-side intersecting road R3. Further, on the opposite-side road R4, the stop line St is also provided on the near side of the intersection IS.

In the example shown in FIG. 2 and the like, the vehicle 1 is traveling on the first lane L11 of the travel road R1 toward the intersection IS. When turning right at the intersection IS, the vehicle 1 travels to the first lane L21 of the right-side intersecting road R2 across an oncoming lane OL. Here, the oncoming lane OL is a lane on which another vehicle (hereinafter, also referred to as an "oncoming vehicle") whose travel direction is opposite to that of the vehicle 1 travels, and is, for example, the second lane L12 of the travel road R1 or the second lane L42 of the opposite-side road R4.

A situation shown in FIG. 2 is a situation in which the vehicle 1 is traveling at a position far away from the intersection IS on the near side and the pedestrian crossing Pc and the stop line St provided on the near side of the intersection IS on the travel road R1 cannot be detected by the external environment sensor 11, in other words, a situation in which the control device 30 cannot recognize the pedestrian crossing Pc and the stop line St provided on the near side of the intersection IS on the travel road R1.

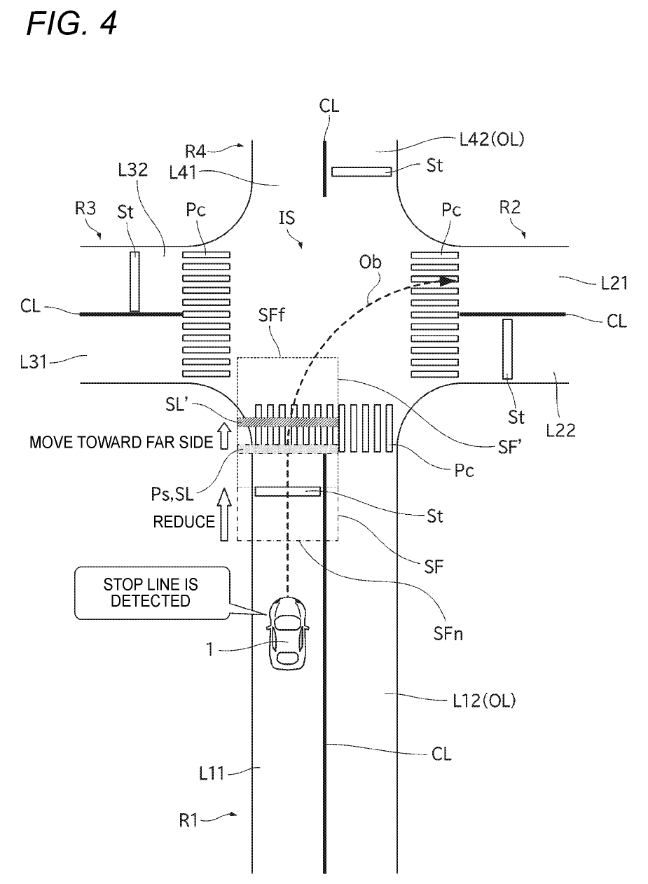

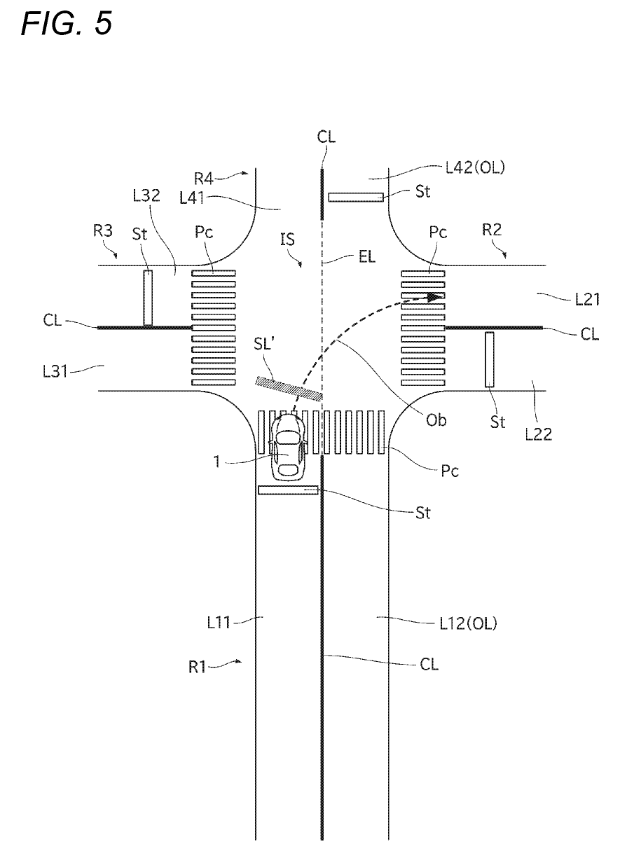

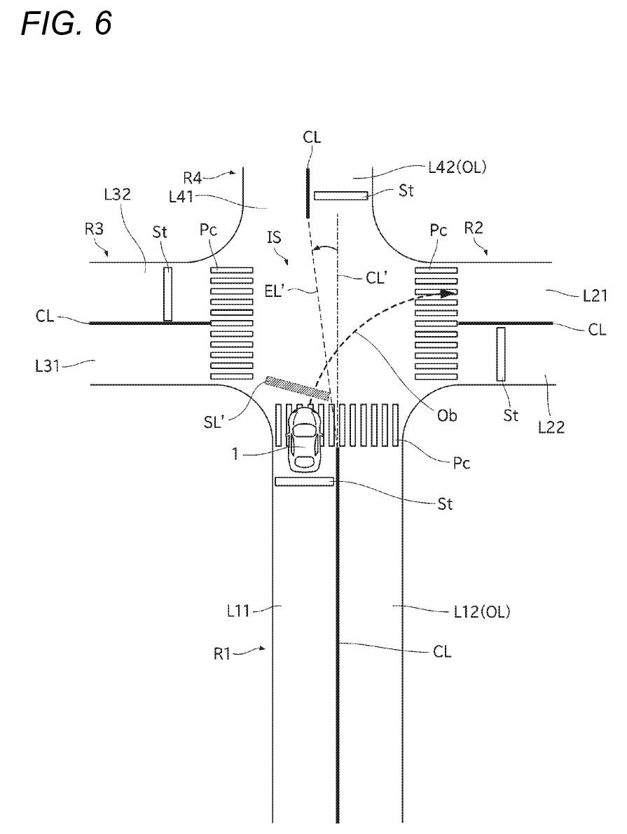

Meanwhile, a situation shown in FIG. 4 is a situation in which the vehicle 1 is traveling at a position considerably close to the intersection IS, and the external environment sensor 11 can detect the stop line St provided on the near side of the intersection IS on the travel road R1 (in other words, the control device 30 can recognize the stop line St). Further, a situation shown in each of FIGS. 5 and 6 is a situation in which the vehicle 1 enters the intersection IS beyond the stop line St of the travel road R1 and is immediately before turning right at the intersection IS (that is, immediately before traveling to the right-side intersecting road R2).

### Stop Position Estimation Unit

The stop position estimation unit 31 of the control device 30 estimates the stop position SL of the vehicle 1 at the intersection IS when the vehicle 1 is scheduled to travel to the right-side intersecting road R2 across the oncoming lane OL. The stop position estimation unit 31 can determine whether the vehicle 1 is scheduled to travel to the right-side intersecting road R2 based on, for example, the route guidance performed by the navigation device 20 or a lighting state of a direction indicator (not shown) provided in the vehicle 1. When the vehicle 1 is an autonomous driving vehicle that autonomously travels, the stop position estimation unit 31 may determine whether the vehicle 1 is scheduled to travel to the right-side intersecting road R2 based on a travel plan generated based on a route to a destination of the vehicle 1.

For example, as shown in FIG. 2, when the pedestrian crossing Pc and the stop line St provided on the near side of the intersection IS on the travel road R1 cannot be detected by the external environment sensor 11, the stop position estimation unit 31 estimates a turning start position Ps of the vehicle 1 when traveling to the right-side intersecting road R2 as the stop position SL, based on the map information DB 24 (for example, the SD map).

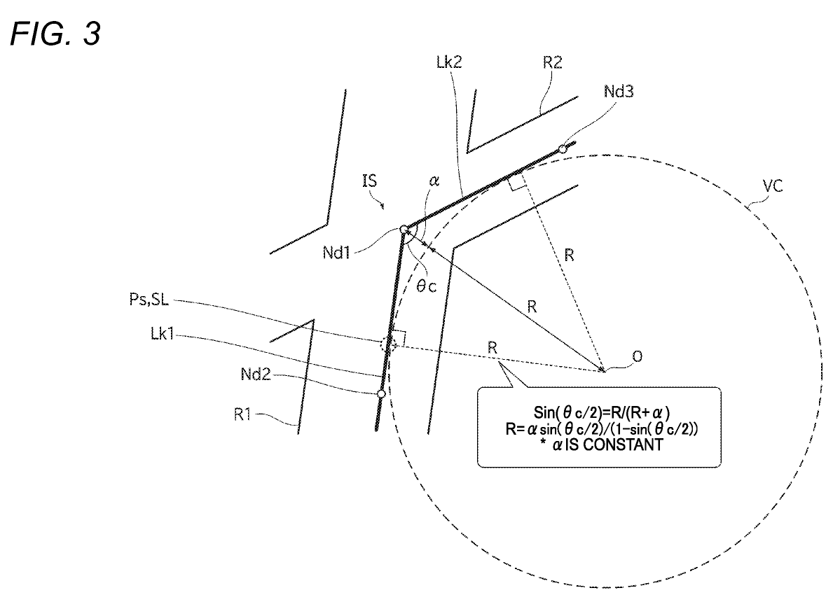

Here, an example of a method of deriving the turning start position Ps by the stop position estimation unit 31 will be described with reference to FIG. 3.

A node Nd1 shown in FIG. 3 is a node corresponding to the intersection IS (that is, an intersection where the vehicle 1 is scheduled to turn right) in the map information DB 24 (specifically, the road network information), and is, for example, a node indicating a center point of the intersection IS.

A travel road link Lk1 is a link corresponding to the travel road R1 on which the vehicle 1 is traveling, and is a link having one end connected to the node Nd1. The other end of the travel road link Lk1 is connected to a node Nd2 corresponding to a point on the near side relative to the intersection IS on the travel road R1.

An intersecting road link Lk2 is a link corresponding to the right-side intersecting road R2 on which the vehicle 1 is scheduled to travel, and is a link having one end connected to the node Nd1. Further, the other end of the intersecting road link Lk2 is connected to a node Nd3 corresponding to a point ahead of the intersection IS on the right-side intersecting road R2.

In deriving the turning start position Ps, the stop position estimation unit 31 first derives an intersection angle θc between the travel road link Lk1 and the intersecting road link Lk2 based on the travel road link Lk1 and the intersecting road link Lk2. The intersection angle θc can be geometrically obtained from the travel road link Lk1 (in other words, a line segment passing through the node Nd1 and the node Nd2) and the intersecting road link Lk2 (in other words, a line segment passing through the node Nd1 and the node Nd3).

Next, the stop position estimation unit 31 derives a radius R (a unit is, for example, [m]) of a virtual arc VC tangent to both the travel road link Lk1 and the intersecting road link Lk2 based on the intersection angle θc.

As shown in FIG. 3, the radius R of the arc VC is obtained by solving an equation R = αsin(θc/2)/(1−sin(θc/2), for example. Here, α is a predetermined constant, and can be, for example, 4 [m]. However, α is not limited thereto, and can be freely determined by a manufacturer or the like of the vehicle 1. For example, the stop position estimation unit 31 may use, as α, a value that varies depending on a size of the intersection itself or magnitude of the intersection angle θc.

Then, as shown in FIG. 3, the stop position estimation unit 31 sets a position corresponding to a contact point between the arc VC and the travel road link Lk1 when the arc VC is tangent to both the travel road link Lk1 and the intersecting road link Lk2 as the turning start position Ps, and estimates the turning start position Ps as the stop position SL.

More specifically, an center O shown in FIG. 3 is a center of the arc VC when the arc VC is tangent to both the travel road link Lk1 and the intersecting road link Lk2. The turning start position Ps is the position corresponding to the contact point between the arc VC and the travel road link Lk1, and thus can also be referred to as a position corresponding to an intersection point between a perpendicular line drawn from the center O to the travel road link Lk1 and the travel road link Lk1.

As described above, the stop position estimation unit 31 estimates, as the stop position SL, the turning start position Ps when the vehicle 1 travels to the right-side intersecting road R2 across the oncoming lane OL, based on the map information DB 24 (for example, the SD map). Accordingly, when the vehicle 1 turns right across the oncoming lane OL, even if no information on the stop line St is included in the map information DB 24, a position at which the vehicle 1 is considered to start to travel toward an oncoming lane OL side can be estimated as the stop position SL. Therefore, an appropriate position suitable for a sense of the occupant (that is, the user) of the vehicle 1 can be set as the stop position SL while also considering the oncoming vehicle traveling in the oncoming lane OL.

Since the stop position estimation unit 31 estimates the turning start position Ps based on the travel road link Lk1 and the intersecting road link Lk2 and estimates the turning start position Ps as the stop position SL, the stop position SL can be estimated using link information included in the general map information.

### Stop Position Correction Unit

The stop position correction unit 32 of the control device 30 corrects the stop position SL estimated by the stop position estimation unit 31, based on the detection result of the external environment sensor 11 provided in the vehicle 1.

Specifically, as shown in FIG. 2, when the stop position SL is estimated by the stop position estimation unit 31, the stop position correction unit 32 sets a predetermined range in front of and behind the stop position SL as a stop position frame SF. Here, a near-side boundary SFn of the stop position frame SF is, for example, a position on a near side relative to the stop position SL along the travel road R1 by a predetermined distance d. Further, a far-side boundary SFf of the stop position frame SF is, for example, a position on a far side relative to the stop position SL along the travel road R1 by the predetermined distance d. That is, the stop position SL is a central position of the stop position frame SF in a front-rear direction.

The distance d is preferably set to a value such that the pedestrian crossing Pc, the stop line St, or the like provided on the near side of the intersection IS on the travel road R1 is included in the stop position frame SF while also considering an error or the like of the map information DB 24 (for example, the SD map), and can be set to, for example, 10 [m]. However, the distance d is not limited thereto, and can be freely determined by, for example, the manufacturer of the vehicle 1.

Then, when the stop line St or the pedestrian crossing Pc provided on the near side of the intersection IS on the travel road R1 is detected by the external environment sensor 11, the stop position correction unit 32 corrects the stop position SL toward the far side relative to that before the stop line St or the pedestrian crossing Pc is detected.

Specifically, as shown in FIG. 2, it is assumed that the stop position frame SF including positions of the pedestrian crossing Pc and the stop line St is set in a situation where the pedestrian crossing Pc and the stop line St provided on the near side of the intersection IS on the travel road R1 cannot be detected by the external environment sensor 11.

In a state where such a stop position frame SF is set, as shown in FIG. 4, when the stop line St provided on the near side of the intersection IS on the travel road R1 is detected by the external environment sensor 11, the stop position correction unit 32 reduces the stop position frame SF by moving the near-side boundary SFn of the stop position frame SF shown in FIG. 2 toward the far side, and corrects the stop position SL such that a central position in the front-rear direction of a stop position frame SF′ after reduction is a stop position SL′ after correction (in other words, a new stop position SL).

For example, when the stop line St is detected by the external environment sensor 11 as described above, the stop position correction unit 32 corrects the stop position SL toward the far side relative to the detected stop line St. Specifically, in this case, as shown in FIG. 4, the stop position correction unit 32 reduces the stop position frame SF by moving the near-side boundary SFn toward the far side such that the near-side boundary SFn of the stop position frame SF coincides with a position of a far-side end portion of the detected stop line St.

A central position in the front-rear direction of the stop position frame SF′ after reduction is a position on the far side relative to a central position in the front-rear direction of the stop position frame SF before reduction. Therefore, as shown in FIG. 4, the stop position SL′ after correction is a position on the far side relative to the stop position SL before correction. Accordingly, when the stop line St provided on the near side of the intersection IS on the travel road R1 is detected by the external environment sensor 11, the stop position correction unit 32 can correct the stop position SL toward the far side relative to that before the stop line St is detected.

Here, an example in which the stop line St is detected has been described, but the present disclosure is not limited thereto. For example, when the pedestrian crossing Pc provided on the near side of the intersection IS on the travel road R1 is detected by the external environment sensor 11 instead of the stop line St, the stop position correction unit 32 may also reduce the stop position frame SF by moving the near-side boundary SFn of the stop position frame SF toward the far side, and correct the stop position SL such that the central position in the front-rear direction of the stop position frame SF′ after reduction is the stop position SL′ after correction.

In general, the stop line St is provided on the near side relative to the pedestrian crossing Pc. Therefore, for example, the stop position correction unit 32 may move the near-side boundary SFn of the stop position frame SF toward the far side (that is, reduce the stop position frame SF) when the stop line St is detected, and then further move the near-side boundary SFn of the stop position frame SF toward the far side when the pedestrian crossing Pc is detected.

As described above, when the stop line St or the pedestrian crossing Pc provided on the near side of the intersection IS is detected by the external environment sensor 11, the stop position correction unit 32 corrects the stop position SL toward the far side relative to that before the stop line St or the pedestrian crossing Pc is detected. For example, when the stop line St is detected by the external environment sensor 11, the stop position correction unit 32 corrects the stop position SL toward the far side relative to the above stop line St. Accordingly, the stop position SL (the stop position SL′ after correction) can approach a position suitable for the vehicle 1 to wait for turning right (to wait for turning left in a right-hand traffic region).

Further, when the stop position SL is estimated by the stop position estimation unit 31, the stop position correction unit 32 sets a predetermined range in front of and behind the stop position SL as the stop position frame SF. Then, when the stop line St or the pedestrian crossing Pc is detected by the external environment sensor 11 and the position of the stop line St or the pedestrian crossing Pc is included in the stop position frame SF, the stop position correction unit 32 reduces the stop position frame SF by moving the near-side boundary SFn of the stop position frame SF toward the far side, and corrects the stop position SL such that the central position in the front-rear direction of the stop position frame SF′ after reduction is the stop position SL′ after correction. Accordingly, the stop position frame SF can be appropriately reduced, and an appropriate position can be set as the stop position SL′ after correction based on the stop position frame SF′ after reduction.

Meanwhile, the position of the detected stop line St or pedestrian crossing Pc may not be included in the stop position frame SF. When the stop line St or the pedestrian crossing Pc at a position not included in the stop position frame SF is detected by the external environment sensor 11, the stop line St or the pedestrian crossing Pc is provided at a position away from the intersection IS where the vehicle 1 is scheduled to turn right, and may not be appropriate to be used in correcting the stop position SL. Alternatively, when the stop line St or the pedestrian crossing Pc at a position not included in the stop position frame SF is detected by the external environment sensor 11, a so-called "erroneous detection" may occur in which the external environment sensor 11 erroneously detects the stop line St or the pedestrian crossing Pc for some reason even though the stop line St and the pedestrian crossing Pc are not actually present. In this way, the erroneously detected stop line St or pedestrian crossing Pc is also not appropriate to be used in correcting the stop position SL.

Therefore, when the stop line St or the pedestrian crossing Pc is detected by the external environment sensor 11 and the position of the stop line St or the pedestrian crossing Pc is not included in the stop position frame SF, the stop position correction unit 32 preferably does not correct the stop position ST based on the stop line St or the pedestrian crossing Pc. That is, when the stop line St or the pedestrian crossing Pc is detected by the external environment sensor 11 and the position of the stop line St or the pedestrian crossing Pc is not included in the stop position frame SF, the stop position correction unit 32 may maintain the stop position frame SF as before the stop line St or the pedestrian crossing Pc is detected. In this way, unnecessary correction of the stop position SL can be prevented, a processing load of the control device 30 can be reduced, and deviation of the stop position SL from an appropriate position due to unnecessary correction can be prevented.

As shown in FIG. 5, when the vehicle 1 is in a situation of entering the intersection IS beyond the stop line St of the travel road R1 and immediately before turning right at the intersection IS, the stop position correction unit 32 may correct the stop position SL based on, for example, a virtual extension line EL extending toward the intersection IS from an end portion of the central division line CL of the travel road R1 on an intersection IS side. Here, as shown in FIG. 5, the extension line EL can be, for example, a line segment passing through the end portion of the central division line CL of the travel road R1 on the intersection IS side and an end portion of the central division line CL of the opposite-side road R4 on the intersection IS side.

In this case, for example, the stop position correction unit 32 may set, as the stop position SL′ after correction (in other words, the new stop position SL), a position on the far side relative to the stop line St of the travel road R1 and on a left side of the extension line EL, that is, a position in the intersection IS at which the vehicle 1 does not protrude to the oncoming lane OL side. Alternatively, the stop position correction unit 32 may set, as the stop position SL′ after correction, for example, a position on a travel trajectory Ob to be described later and on the left side of the extension line EL with the vehicle 1 not protruding to the oncoming lane OL side.

In this way, when the vehicle 1 is in a situation immediately before turning right at the intersection IS, the stop position correction unit 32 can set the stop position SL to a position suitable for the vehicle 1 to wait for turning right by correcting the stop position SL based on the extension line EL.

Further, as shown in FIG. 6, it is also conceivable that the opposite-side road R4 is shifted to the left and right sides with respect to the travel road R1, that is, the intersection IS is a so-called "offset intersection". In order to cope with such an offset intersection, the stop position correction unit 32 may correct the stop position SL based on a virtual extension line EL′ extending from the travel road R1 toward the opposite-side road R4 through the intersection IS.

Here, similarly to the extension line EL, the extension line EL′ can be, for example, a line segment passing through an end portion of the central division line CL of the travel road R1 on the intersection IS side and an end portion of the central division line CL of the opposite-side road R4 on the intersection IS side. Accordingly, as shown in FIG. 6, when the intersection IS is an offset intersection, the extension line EL′ can be inclined by a predetermined angle with respect to an extension line CL′ of the central division line CL of the travel road R1. In other words, the extension line EL′ may be a virtual line inclined by an angle corresponding to a positional relationship between the travel road R1 and the opposite-side road R4 with respect to the extension line CL′ of the central division line CL of the travel road R1.

In this way, by correcting the stop position SL based on the virtual extension line EL′ extending from the travel road R1 toward the opposite-side road R4 through the intersection IS, even when the opposite-side road R4 is not located in front of the travel road R1 with the intersection IS interposed therebetween, an appropriate position in consideration of the oncoming vehicle traveling in the oncoming lane OL can be set as the stop position SL′ after correction.

### Travel Control Unit 33

The travel control unit 33 of the control device 30 performs deceleration control on the vehicle 1 based on the stop position SL (including the stop position SL′ after correction) estimated by the stop position estimation unit 31. More specifically, the travel control unit 33 may gently decelerate the vehicle 1 from a position on the near side relative to the stop position SL such that "rapid deceleration" accompanied by deceleration of a predetermined value or more does not occur.

Further, when the vehicle 1 is an autonomous vehicle that autonomously travels, the travel control unit 33 may generate the travel trajectory Ob (see FIGS. 2 and 4 to 6) from the stop position SL toward the right-side intersecting road R2 across the oncoming lane OL, and control steering, acceleration, deceleration, and the like of the vehicle 1 such that the vehicle 1 travels based on the generated travel trajectory Ob.

### 7. Example of Processing Procedure Performed by Control Device

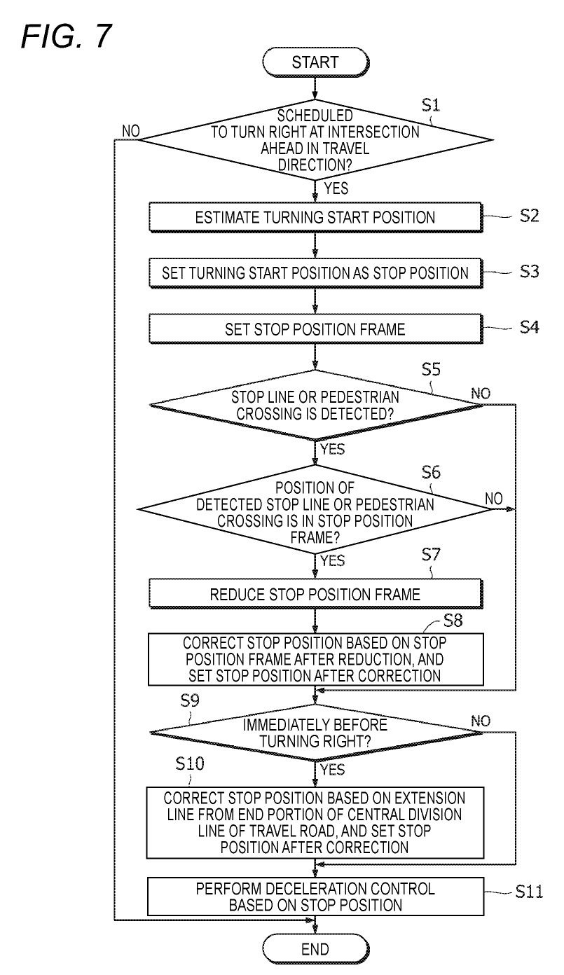

Next, an example of a processing procedure by the control device 30 will be described. FIG. 7 is a flowchart showing the example of the processing procedure performed by the control device 30. For example, when an ignition power supply of the vehicle 1 is turned on, the control device 30 executes a series of processing shown in FIG. 7 at a predetermined cycle.

As shown in FIG. 7, first, the control device 30 determines whether the vehicle 1 is scheduled to turn right at the intersection IS ahead in the travel direction (step S1). If it is determined that the vehicle 1 is scheduled to turn right at the intersection IS ahead in the travel direction (step S1: YES), the control device 30 estimates the turning start position Ps (step S2). Then, the control device 30 sets the estimated turning start position Ps as the stop position SL (step S3), and sets the stop position frame SF in a predetermined range in front of and behind the stop position SL (step S4).

Next, the control device 30 determines whether the stop line St or the pedestrian crossing Pc provided on the travel road R1 is detected (step S5). If it is determined that the stop line St or the pedestrian crossing Pc is not detected (step S5: NO), the control device 30 proceeds to processing in step S9.

On the other hand, if it is determined that the stop line St or the pedestrian crossing Pc is detected (step S5: YES), the control device 30 determines whether a position of the detected stop line St or pedestrian crossing Pc is within the stop position frame SF (step S6). When it is determined that the position of the detected stop line St or pedestrian crossing Pc is outside the stop position frame SF (step S6: NO), the control device 30 proceeds to the processing in step S9.

On the other hand, if it is determined that the position of the detected stop line St or pedestrian crossing Pc is within the stop position frame SF (step S6: YES), the control device 30 reduces the stop position frame SF (step S7). Then, the control device 30 corrects the stop position SL based on the stop position frame SF′ after reduction, and sets the stop position SL′ after correction (step S8).

Next, the control device 30 determines whether the vehicle 1 enters the intersection IS and is immediately before turning right (step S9). If it is determined that the vehicle 1 is not immediately before turning right (step S9: NO), the control device 30 proceeds to processing in step S11.

If it is determined that the vehicle 1 is immediately before turning right (step S9: YES), the control device 30 corrects the stop position SL based on the extension line EL from the end portion of the central division line CL of the travel road R1, and sets the stop position SL′ after correction (step S10). Then, the control device 30 performs the deceleration control based on the stop position SL (including the stop position SL′ after correction) (step S11), and ends the series of processing shown in FIG. 7.

As described above, the control device 30 estimates, as the stop position SL, the turning start position Ps when the vehicle 1 travels to the right-side intersecting road R2 across the oncoming lane OL based on the map information DB 24. Accordingly, when the vehicle 1 turns right across the oncoming lane OL (turns left in the right-hand traffic region), even if no information on the stop line St is included in the map information DB 24, a position at which the vehicle 1 is considered to start to travel toward the oncoming lane OL side can be estimated as the stop position SL. Therefore, an appropriate position suitable for a sense of the occupant (that is, the user) of the vehicle 1 can be set as the stop position SL while also considering the oncoming vehicle traveling in the oncoming lane OL, and the deceleration control on the vehicle 1 can be performed based on the appropriate stop position SL.

According to the control device 30, since the stop position SL can be estimated based on the map information DB 24, the deceleration control on the vehicle 1 based on the estimated stop position SL can be performed before the stop line St or the like is detected by the external environment sensor 11 provided in the vehicle 1.

Further, the control device 30 can correct the stop position SL to an appropriate position by reducing the stop position frame SF and correcting the stop position SL when a predetermined range in front of and behind the set stop position SL is set as the stop position frame SF and the position of the stop line St or the pedestrian crossing Pc is within the stop position frame SF.

Further, immediately before the vehicle 1 turning right, the stop position SL is corrected based on the extension line EL from the end portion of the central division line CL of the travel road R1, and thus the control device 30 can bring the stop position SL closer to a position suitable for the vehicle 1 to wait for turning right.

By performing the deceleration control based on the set stop position SL (including the corrected stop position SL′), the control device 30 can perform the deceleration control of the vehicle 1 before the stop line St or the like is detected.

As described above, according to the present embodiment, it is possible to provide the control device 30 capable of estimating the appropriate stop position SL even if no information on the stop line St is included in the map information (for example, the map information DB 24) and appropriately controlling the vehicle 1 based on the stop position SL. In addition, it is possible to improve traffic safety and contribute to the development of the sustainable transportation system.

Although an embodiment of the present disclosure has been described above, it goes without saying that the present disclosure is not limited to the embodiment. It is apparent that those skilled in the art can conceive of various modifications and alterations within the scope described in the claims, and it is understood that such modifications and alterations naturally fall within the technical scope of the present disclosure.

For example, in the above embodiment, the far-side boundary SFf of the stop position frame SF is fixed, and the stop position frame SF is reduced by moving the near-side boundary SFn toward the far side to correct the stop position SL, but the present disclosure is not limited thereto. For example, when the stop position frame SF that intersects the central division line CL of the right-side intersecting road R2 or the central division line CL of the opposite-side road R4 is set, the stop position frame SF may be reduced by moving the far-side boundary SFf toward the near side.

Further, when the stop line St or the pedestrian crossing Pc is detected in the stop position frame SF, the stop position frame SF may be reduced, and when the stop line St or the pedestrian crossing Pc is detected outside the stop position frame SF, the reduction of the stop position frame SF may be prevented as erroneous detection.

When there is an obstacle in the stop position frame SF, the stop position SL is not limited to the central position of the stop position frame SF, and the stop position SL may be adjusted to a position on the far side or the near side relative to the central position of the stop position frame SF.

In the present description and the like, at least the following matters are described. Although corresponding constituent elements and the like in the above embodiment are shown in parentheses, the present disclosure is not limited thereto.

(1) A vehicle control device (control device 30) for controlling a vehicle (vehicle 1), including:

a stop position estimation unit (stop position estimation unit 31) configured to, when the vehicle is scheduled to travel to an intersecting road (right-side intersecting road R2) across an oncoming lane (oncoming lane OL) at an intersection (intersection IS), estimate a stop position (stop position SL) of the vehicle at the intersection; and

a travel control unit (travel control unit 33) configured to perform travel control on the vehicle, in which

the stop position estimation unit estimates a turning start position (turning start position Ps) of the vehicle when the vehicle travels to the intersecting road as the stop position based on map information, and

the travel control unit performs deceleration control on the vehicle based on the stop position estimated by the stop position estimation unit.

According to (1), the turning start position when the vehicle travels to the intersecting road across the oncoming lane is estimated as the stop position based on the map information. Accordingly, when the vehicle turns right or left across the oncoming lane, even if no information on a stop line is included in the map information, a position at which the vehicle is considered to start to travel toward an oncoming lane side can be estimated as the stop position. Therefore, an appropriate position suitable for a sense of a user can be set as the stop position while also considering an oncoming vehicle traveling in the oncoming lane, and the deceleration control on the vehicle can be performed based on the appropriate stop position. According to (1), since the stop position can be estimated based on the map information, the deceleration control on the vehicle based on the estimated stop position can be performed before the stop line or the like is detected by an external environment sensor provided in the vehicle. In addition, it is possible to improve traffic safety and contribute to the development of the sustainable transportation system.

(2) The vehicle control device according to (1) further including:

a stop position correction unit (stop position correction unit 32) configured to correct, based on a detection result of an external environment sensor (external environment sensor 11) provided in the vehicle, the stop position estimated by the stop position estimation unit, in which

when a stop line (stop line St) or a pedestrian crossing (pedestrian crossing Pc) provided on a near side of the intersection is detected by the external environment sensor, the stop position correction unit corrects the stop position toward a far side relative to that before the stop line or the pedestrian crossing is detected.

According to (2), when the stop line or the pedestrian crossing provided on the near side of the intersection is detected by the external environment sensor, the stop position is corrected toward the far side relative to that before the detection, and thus the stop position can be brought closer to a position suitable for the vehicle to wait for turning right or turning left.

(3) The vehicle control device according to (2), in which

when the stop line is detected by the external environment sensor, the stop position correction unit corrects the stop position toward the far side relative to the stop line.

According to (3), when the stop line is detected by the external environment sensor, the stop position is corrected toward the far side relative to the stop line, and thus the stop position can be brought closer to a position suitable for the vehicle to wait for turning right or turning left.

(4) The vehicle control device according to (2), in which

when the stop position is estimated by the stop position estimation unit, the stop position correction unit sets a predetermined range in front of and behind the stop position as a stop position frame (stop position frame SF), and

when the stop line or the pedestrian crossing is detected by the external environment sensor and a position of the stop line or the pedestrian crossing is included in the stop position frame, the stop position correction unit reduces the stop position frame by moving a boundary of the stop position frame on a near side toward the far side, and corrects the stop position such that a central position of the stop position frame after reduction (stop position frame SF′ after reduction) in a front-rear direction is the stop position after correction (stop position SL′ after correction).

According to (4), the stop position frame can be appropriately reduced, and an appropriate position can be set as the stop position after correction based on the stop position frame after reduction.

(5) The vehicle control device according to (2), in which

when the stop position is estimated by the stop position estimation unit, the stop position correction unit sets a predetermined range in front of and behind the stop position as a stop position frame, and

when the stop line or the pedestrian crossing is detected by the external environment sensor and a position of the stop line or the pedestrian crossing is not included in the stop position frame, the stop position correction unit does not correct the stop position based on the stop line or the pedestrian crossing.

The stop line or the pedestrian crossing at a position not included in the stop position frame is away from the intersection at which the vehicle is about to turn right or left across the oncoming lane, and may not be appropriate to be used in correcting the stop position. According to (5), by not correcting the stop position based on such a stop line or pedestrian crossing, unnecessary correction can be prevented, a processing load of the vehicle control device can be reduced, and deviation of the stop position from an appropriate position due to the unnecessary correction can be prevented.

(6) The vehicle control device according to (1), in which

the map information includes a link indicating a position and an extending direction of a road, and

the stop position estimation unit

derives an intersection angle (intersection angle θc) between a travel road link (travel road link Lk1) that is a link corresponding to a travel road on which the vehicle is traveling and an intersecting road link (intersecting road link Lk2) that is a link corresponding to the intersecting road based on the travel road link and the intersecting road link,

derives a radius (radius R) of a virtual arc (arc VC) that is tangent to both the travel road link and the intersecting road link based on the intersection angle, and

sets, as the turning start position, a position corresponding to a contact point between the arc and the travel road link when the arc is tangent to both the travel road link and the intersecting road link, and estimates the turning start position as the stop position.

According to (6), the stop position can be estimated using information of the link included in a general map information which is not so-called "high-definition map information”.

(7) The vehicle control device according to (2), in which

the stop position correction unit corrects the stop position based on a virtual extension line (extension line EL) extending toward the intersection from an end portion on an intersection side of a central division line (central division line CL) provided on a travel road (travel road R1) on which the vehicle is traveling.

According to (7), by correcting the stop position based on the extension line from the central division line of the travel road on which the vehicle is traveling, the stop position can be brought closer to a position suitable for the vehicle to wait for turning right or turning left.

(8) The vehicle control device according to (7), in which

the extension line extends toward an opposite-side road (opposite-side road R4) on an opposite side of the travel road with the intersection interposed therebetween.

According to (8), even when the opposite-side road is not located in front of the travel road with the intersection interposed therebetween, the stop position can be corrected to an appropriate stop position in consideration of the oncoming vehicle traveling in the oncoming lane.

1. A vehicle control device for controlling a vehicle, comprising:
a processor configured to:
estimate, when the vehicle is scheduled to travel to an intersecting road across an oncoming lane at an intersection, a stop position of the vehicle at the intersection; and
perform travel control on the vehicle, wherein
the processor estimates a turning start position of the vehicle when the vehicle travels to the intersecting road as the stop position based on map information, and
the processor performs deceleration control on the vehicle based on estimated the stop position.

2. The vehicle control device according to claim 1, wherein
the processor is configured to correct the estimated stop position based on a detection result of an external environment sensor provided in the vehicle, wherein
when a stop line or a pedestrian crossing provided on a near side of the intersection is detected by the external environment sensor, the processor corrects the stop position toward a far side relative to that before the stop line or the pedestrian crossing is detected.

3. The vehicle control device according to claim 2, wherein
when the stop line is detected by the external environment sensor, the stop position correction unit corrects the stop position toward the far side relative to the stop line.

4. The vehicle control device according to claim 2, wherein
when estimating the stop position, the processor sets a predetermined range in front of and behind the stop position as a stop position frame, and
when the stop line or the pedestrian crossing is detected by the external environment sensor and a position of the stop line or the pedestrian crossing is included in the stop position frame, the processor reduces the stop position frame by moving a boundary of the stop position frame on a near side toward the far side, and corrects the stop position such that a central position of the stop position frame after reduction in a front-rear direction is the stop position after correction.

5. The vehicle control device according to claim 2, wherein
when estimating the stop position, the processor sets a predetermined range in front of and behind the stop position as a stop position frame, and
when the stop line or the pedestrian crossing is detected by the external environment sensor and a position of the stop line or the pedestrian crossing is not included in the stop position frame, the processor does not correct the stop position based on the stop line or the pedestrian crossing.

6. The vehicle control device according to claim 1, wherein
the map information includes a link indicating a position and an extending direction of a road, and
the processor derives an intersection angle between a travel road link that is a link corresponding to a travel road on which the vehicle is traveling and an intersecting road link that is a link corresponding to the intersecting road based on the travel road link and the intersecting road link,
the processor derives a radius of a virtual arc that is tangent to both the travel road link and the intersecting road link based on the intersection angle, and
the processor sets, as the turning start position, a position corresponding to a contact point between the arc and the travel road link when the arc is tangent to both the travel road link and the intersecting road link, and estimates the turning start position as the stop position.

7. The vehicle control device according to claim 2, wherein
the processor corrects the stop position based on a virtual extension line extending toward the intersection from an end portion on an intersection side of a central division line provided on a travel road on which the vehicle is traveling.

8. The vehicle control device according to claim 7, wherein
the extension line extends toward an opposite-side road on an opposite side of the travel road with the intersection interposed therebetween.
